(19) United States
(12) Patent Application Publication
(10) Pub. No.: US 2017/0352300 A1
(43) Pub. Date: Dec. 7, 2017

(54) DISPLAY FRAME FOR USE WITH LICENSE PLATES

(71) Applicant: Glen Trevillion, Atlanta, GA (US)

(72) Inventor: Glen Trevillion, Atlanta, GA (US)

(21) Appl. No.: 15/175,217

(22) Filed: Jun. 7, 2016

(51) Int. Cl. G09F 7/18

(52) U.S. Cl. CPC G09F 7/18; G09F 2007/1895; G09F 2007/1804; G09F 2007/1843; G09F 2007/1852

(57) ABSTRACT

A display frame for use in exhibiting license plates on a table/desk or from the floor include a frame body defining a hingedly connected front frame member and back frame member, a coupling member, and either plurality of magnets, a table stand or a floor stand. The back frame member and the front frame member each include a plurality of cushion pads in corresponding location to allow the frame body to be secured over and hold a contained license plate without damaging the license plate. The frame body may be deployed with either magnets, a table stand or a floor stand, with the coupling member facilitating the removable attachment of the frame body to either of the stands.

### BACKGROUND OF THE INVENTION

### Field of the Invention

This invention relates generally to exhibiting structures and, more particularly, to a hinged display frame for use with license plates and which is freestanding and magnetically mountable.

### Description of the Prior Art

The collection of license plates from different states and or countries is a hobby enjoyed by many. A problem which still exists, however, is that there are not many desirable structures which can be used for displaying collected license plates either on a table or from the floor. Indeed, an individual wishing to display collected license plates is often forced to customize their own display structure or just attach the license plate directly to a wall. Thus, there remains a need for a display frame for use with license plates that can receive and securely hold a license plate for exhibiting. It would be helpful if such a display frame included a hingedly connected front and back frame member which allows license plates to be interchanged as desired by a user without compromising the ability to securely hold the plate. It would be additionally desirable for such a display frame to include a plurality of magnets, a table stand or a floor stand in order to allow it to be mounted or positioned in a desired location.

The Applicant's invention described herein provides for a display frame adapted to allow a user to securely but removably position a license plate therein for exhibiting. The primary components in Applicant's magnetic display frame are a front frame member, a back frame member, and a coupling member. When in operation, the magnetic display frame enables more effective and convenient exhibiting of license plates on a refrigerator or from a table/desk or a floor. As a result, many of the limitations imposed by prior art structures are removed.

### SUMMARY OF THE INVENTION

A display frame for use in exhibiting license plates on a table/desk or from the floor. The display frame comprises a frame body, a coupling member, and in some embodiments, either a table stand or a floor stand. The frame body defines a front frame member and back frame member are hingedly connected so as to allow them to move between an open position and a closed position and includes a plurality of fastener tabs to allow them to be fixed in the closed position. The back frame member and the front frame member each include a plurality of cushion pads which to allow the frame body to be snapped over and hold a contained license plate without damaging the license plate. The frame body may be deployed with either a plurality of magnets, a table stand, or a floor stand, and the coupling member facilitates the removable attachment of the frame body to either of the stands.

It is an object of this invention to provide a display frame for use with license plates that can receive and securely hold a license plate for exhibiting.

It is another object of this invention to provide a display frame with a hingedly connected front and back frame member which allows license plates to be interchanged as desired by a user without compromising the ability to securely hold the plate.

It is yet another object of this invention to provide a display frame to with a plurality of magnets, a table stand or a floor stand in order to allow it to be mounted or positioned in a desired location.

These and other objects will be apparent to one of skill in the art.

### BRIEF DESCRIPTION OF THE DRAWINGS

FIG. 1 is a side perspective view of a display frame for use with license plates built in accordance with the present invention attached to a table stand and having its front frame member and back frame member hinged apart in an open position.

FIG. 2 is a side perspective view of a display frame for use with license plates built in accordance with the present invention attached to a table stand and having its front frame member and back frame member hinged apart in an open position and a license plate attached to the back from member.

FIG. 3 is a front elevational view of a display frame for use with license plates built in accordance with the present invention attached to a table stand and with a license plate disposed therein.

FIG. 4 is a front elevational view of a display frame for use with license plates built in accordance with the present invention attached to a floor stand and with a license plate disposed therein.

FIG. 5 is a rear elevational view of a display frame for use with license plates built in accordance with the present invention.

### DETAILED DESCRIPTION OF THE INVENTION

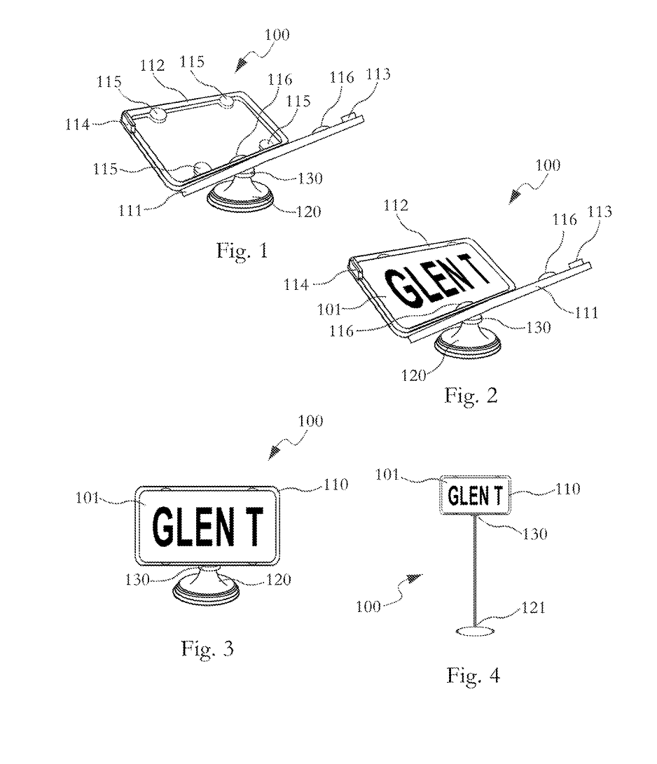

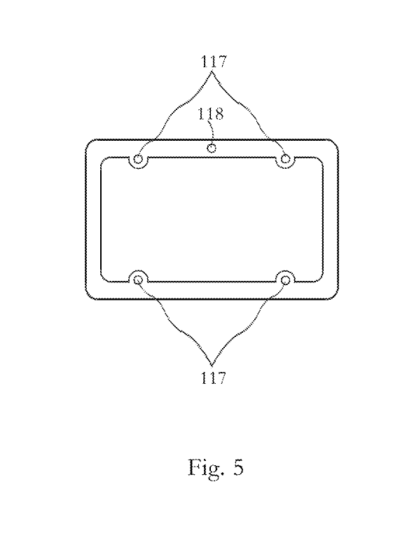

Referring now to the drawings and in particular FIGS. 1, 2, 3, 4, and 5, a display frame 100 for use with license plates is shown having a frame body 110 with a front frame member 111 and a back frame member 112, a stand 120, 121, and a coupling member 130. In one embodiment, the front frame member 111 and back frame member 112 are hingedly connected so as to allow them to move between an open position, as illustrated in FIGS. 1 and 2, and a closed position, as illustrated in FIGS. 3 and 4. The front frame member 111 includes a fastener tab 113 on one side and the back from member 112 includes a fastener tab 114 on the opposite side. The fastener tabs 113, 114 each define mechanical clips having tab protrusions which operate to engage the edge of the opposing frame member when the front frame member 111 and back frame member 112 are pressed together.

In other embodiments, it is contemplated that the front frame member 111 and back frame member 112 may be connectable in through alternate mechanisms, such as through magnetic attachment or mechanical fasteners.

The back frame member 112 includes a plurality of back cushion pads 115 on which a license plate 101 may rest when positioned thereon. The front frame member 111 also includes a front cushion pad 116 which corresponds to each of the back cushion pads 115 on the back frame member 112 and is positioned on the front frame member 111 opposite its corresponding back cushion pads 115. The cushion pads 115, 116 provide shock absorption and allow the frame body 110 to be snapped over a contained license plate 101 without damaging the license plate 101.

The frame body 110 may be deployed with a plurality of magnets 117, a frame hook aperture 118, a table stand 120 or a floor stand 121. With the magnets 117 or a frame hook 118, it is contemplated that the frame body 110 may be attached to a refrigerator (not shown) or wall mounting hook (not shown), respectively.

When it is desired to use the table stand 120 or floor stand 121, the coupling member 130 is deployed to enable the connection. The coupling member 130 defines a magnetic coupler which operates to attach the frame body 110 to either of the stands 120, 121. In this regard, it is contemplated that the bottom of the frame body 110 and the top of the stands are each constructed of or otherwise include a ferromagnetic material. In an alternate embodiment, however, the coupling member 130 may include a threaded portion which can engage a threaded portion at the top of the stands 120, 121.

It is contemplated that the frame body 110 is generally constructed out of a rigid material, such as a rigid plastic or metal. In any event, as discussed previously, the bottom of the frame body 110 must include at least a strip of ferromagnetic material to facilitate attaching to the coupling member 130.

It is contemplated that the magnets 117 may be attached magnetically to the back frame member 112 (if the back frame member 112 includes ferromagnetic material), with an adhesive, or with another conventional fastener.

In one embodiment, the frame body measures 12 ¼ inches by 6 ¼ inches and the magnets 117 and coupling member 130 each define a neodymium magnet.

The instant invention has been shown and described herein in what is considered to be the most practical and preferred embodiment. It is recognized, however, that departures may be made therefrom within the scope of the invention and that obvious modifications will occur to a person skilled in the art.

1. A display frame for use in exhibiting license plates, comprising:
a frame body having includes a front frame member that is attachable to a back frame member, wherein the frame body is selectively positionable in a closed position and adapted to hold a license plate when in the closed position;
said back frame member and said front frame member each having a plurality of cushion pads, wherein said cushion pads are configured to extend from a surface of the back frame member and front frame member so as to absorb all contact between the frame body and a license plate contained therein when the frame body is in the closed position;
at least one of a table stand and a floor stand;
a coupling member defining a magnetic coupler and adapted to selectively attach the frame body to either of the at least one of the table stand and floor stand;
a bottom surface of the frame body includes a ferromagnetic material;
a top surface of the at least one of the table stand and the floor stand includes a ferromagnetic material; and
wherein at least one of the front frame member and back frame member includes a fastener tab which holds the front frame member and back frame member together when in the closed position.

2. The display frame of claim 1, wherein said front frame member is hingedly attached to the back frame member such that the frame body is selectively movable between an open position and the closed position.

3. The display frame of claim 1, wherein said frame body is adapted to attach to a vertical surface.

4. The display frame of claim 3, wherein said back frame member includes at least one magnet, thereby adapted the frame body to attach to a ferromagnetic surface.

5. The display frame of claim 3, wherein said back frame member includes frame hook aperture, thereby adapted the frame body to attach to a surface having a hook.

6.-10. (canceled)

11. (canceled)

12.-14. (canceled)
